(19) United States
(12) Patent Application Publication
(10) Pub. No.: US 2012/0021961 A1
(43) Pub. Date: Jan. 26, 2012

(54) COMPOSITION FOR POST CHEMICAL-MECHANICAL POLISHING CLEANING

(75) Inventors: Andreas Klipp, Lambsheim (DE); Ting Hsu Hung, Siaogang District (TW); Kuochen Su, Taoyuan County (TW); Sheng-Hung Tu, Kaohsiung County (TW)

(73) Assignee: BASF SE, Ludwigshafen (DE)

(21) Appl. No.: 13/145,257

(22) PCT Filed: Jan. 6, 2010
(86) PCT No.: PCT/EP10/50078

§ 371 Date: Jul. 22, 2011

(30) Foreign Application Priority Data
Jan. 22, 2009 (CN) 200910005276.8
Jan. 22, 2009 (TW) 098102676

(51) Int. Cl. C11D 3/30

(52) U.S. Cl. 510/175

(57) ABSTRACT

The present invention relates to a composition for post chemical-mechanical polishing (CMP) cleaning. The composition is alkaline, which can remove azole-type corrosion inhibitors on the wafer surface after CMP. This composition can effectively remove azole compounds, increase wettability of the Cu surface, and significantly improve the defect removal after CMP.

### FIELD OF THE INVENTION

The present invention relates to a composition for post chemical-mechanical polishing (CMP) cleaning (PCC) for integrated circuits.

### BACKGROUND OF THE INVENTION

The current development of semi-conductor devices is heading toward the decrease of line pitch dimension and the increase of integration density. With the increase in the number of layers and decrease in line pitch dimension of the integrated circuits, the RC-delay caused by the inherent resistance of the metal wire and the parasitic capacitance of the dielectric layers becomes significant. In order to eliminate the RC-delay problem and increase the signal transmission speed, the copper metallization (Cu wire) process has gradually replaced the conventional aluminum metallization (Al wire) process; in this way, the inherent resistance of the metal wire is reduced. Thus, the development of copper chemical-mechanical polishing (Cu CMP) becomes one of the most important technologies in the advanced sub-micron semi-conductor process employing the Cu process. In the current advanced semi-conductor process, the number of the Cu wire layers has reached ten, and this number is expected to continuously increase in the future. This also indicates that several CMP and post CMP cleaning steps are involved in the manufacture process, and their number will increase in the future.

In a Cu CMP process, the wafer may be contaminated by Cu ions, CMP slurry particles, and Cu and silica clusters remaining on the surface, including Cu layers and dielectric layers, of the wafer. Therefore, after a CMP step, a cleaning step is usually followed to remove contaminants.

Generally, the post CMP cleaning is the last step of the CMP process, serving the purpose of providing a clean wafer surface to facilitate the subsequent manufacture process.

In order to reduce the yield loss, the following should be noted during CMP and post CMP cleaning.

(1) the azole-type corrosion inhibitors should be removed efficiently;

(2) the accumulation of process stress should be effectively controlled;

(3) suitable low-k material should be chosen to meet the requirements of the CMP process and post CMP cleaning; and

(4) the scratch problem should be avoided.

Different compositions for the post CMP cleaning process are disclosed in prior art documents. For example, U.S. Pat. No. 6,541,434 to Wang discloses a cleaning composition comprising a carboxylic acid, an amine-containing compound, a phosphonic acid, and water for removing abrasive residues as well as metal contaminants following CMP. U.S. Pat. No. 6,627,546 to Kneer discloses a fluoride-free aqueous composition comprising a dicarboxylic acid and/or salt thereof, a hydroxycarboxylic acid and/or salt thereof, or an amine group-containing acid. US Patent Publication No. 2005/0014667 of Aoyama et al. discloses a dilute aqueous remover containing a fluoride-containing compound (surfactant), water, an amide, an ether solvent, and an acid selected from amino sulphonic acid, phosphonic acid, and a soluble phosphonic acid derivative, or a combination thereof. U.S. Pat. No. 7,297,670 to Misra discloses a composition containing a cleaning agent, a corrosion inhibitor, and mercaptopropionic acid. US Patent Publication No. 2004/0204329 of Abe et al. discloses a cleaning liquid composition including a specific ether organic solvent, and the cleaning composition liquid has good wettability to hydrophobic substrates. U.S. Pat. No. 7,208,409 to Zhang et al. discloses a solution for post CMP treatment, which contains a nonionic surfactant of acetylenediol derivative.

The contaminant removal rate of a post CMP cleaning solution is directly related to pH value and zeta potential. Generally, a low zeta potential provides a better contaminant removal rate. Moreover, because alkaline compositions have lower zeta potentials, they are more suitable for use as a post CMP cleaning composition.

Furthermore, in addition to contaminant removal rate, an excellent post CMP cleaning solution should meet the following requirements:

(1) the cleaning solution will not attack or etch a metal (e.g., Cu layer as metal interconnection) or a metal nitride (e.g., TaN or TiN as a barrier layer); and

(2) the cleaning solution will not attack or etch a dielectric layer such as silica, high density low-k materials or porous low-k materials.

Therefore, although various post CMP cleaning solutions are provided in a number of prior art references, a composition for post CMP cleaning capable of effectively removing the contaminants remaining on the surface of a wafer, decreasing the defect count on the surface of the wafer, and not destroying or etching the structure of a substrate is still needed in the industry.

### SUMMARY OF THE INVENTION

The present invention is directed to a composition for post CMP cleaning which comprises at least a water soluble amine, at least a water soluble organic solvent, and deionized water. The composition of the present invention can effectively remove the contaminants remaining on the surface of the wafer after polishing and reduce the defect count on the surface of the wafer after contacting a copper-containing semiconductor wafer for an effective period of time.

The present invention also provides a method of post CMP cleaning comprising the step of contacting a wafer which undergoes CMP with a composition comprising at least a water soluble amine, at least a water soluble organic solvent and deionized water for an effective duration to remove the residual contaminants on the wafer after the CMP.

### BRIEF DESCRIPTION OF THE DRAWING

FIG. 1 is the results of defect counts on the surfaces of the test wafers measured by a KLA-Tencor surfscan AIT after cleaning.

### DETAILED DESCRIPTION OF THE INVENTION

The composition for post CMP cleaning of the present invention comprises at least a water soluble amine, at least a water soluble organic solvent, and deionized water.

The cleaning composition of the present invention removes the contaminants, especially azole-type corrosion inhibitors, from the surface of a wafer by the redox reaction of the water soluble amine contained therein with the contaminants. The azole-type corrosion inhibitors are generally triazole-type corrosion inhibitors, such as benzotriazole (BTA) and 1,2,4-triazole.

The water soluble amine in the cleaning composition of the present invention can be a diazo or an azo compound, for example, a hydrazine, a hydrazine hydrate, hydrazoic acid, or sodium azide.

In an embodiment of the present invention, the water soluble amine in the cleaning composition is selected from a hydrazine, a hydrazine hydrate, or a combination thereof. In a preferable embodiment of the present invention, the water soluble amine in the cleaning composition is a hydrazine.

The water soluble amine in the cleaning composition of the present invention is present in an amount of about 1 to about 30 wt %, preferably about 1 to about 25 wt %, and more preferably about 1 to about 10 wt %, on the basis of the total weight of the composition.

The cleaning composition of the present invention comprises a water soluble organic solvent, which can reduce the surface tension of the cleaning composition and thus increase the wettability of the surface of the wafer.

The water soluble organic solvent in the cleaning composition of the present invention can be an organic ether, an organic alcohol, an organic ketone, or an organic amide, and preferably is selected from dimethyl sulfoxide (DMSO), a diol compound, N-methyl pyrrolidone (NMP), dimethyl acetamide (DMAC), dimethyl formamide (DMF), or a mixture thereof. The diol compound is preferably diethylene glycol monobutyl ether (BDG), ethylene glycol monoethyl ether, ethylene glycol dimethyl ether, ethylene glycol n-butyl ether, ethylene glycol monobutyl ether acetate, or a mixture thereof.

The water soluble organic solvent in the cleaning composition of the present invention is present in an amount of about 10 to about 59 wt %, preferably about 10 to about 50 wt %, and more preferably about 10 to 25 wt %, on the basis of the total weight of the composition.

The cleaning composition of the present invention comprises deionized water. The deionized water is present in an amount of about 30 to about 89 wt %, preferably about 50 to 85 wt %, and more preferably about 65 to about 85 wt %, on the basis of the total weight of the composition.

Any suitable cleaning tool known in the art can be used in performing the method of post CMP cleaning of the subject invention. The tool can be the one that performs CMP or a different one. The method comprises the step of contacting a wafer which undergoes CMP with a composition comprising at least a water soluble amine, at least a water soluble organic solvent and deionized water for an effective duration to remove the residual contaminants on the wafer after the CMP.

### EXAMPLES

The following embodiments are intended to further illustrate the present invention, and not limit the scope of the present invention, and any modifications and variations easily achieved by persons of ordinary skill in the art fall into the scope of the present invention.

### Example 1

7 wt % of hydrazine, 20 wt % of BDG, and 73 wt % of deionized water were formulated into a cleaning composition of the present invention (Chemical C). The surface tension of Chemical C was determined, 30.46 mN/m. A commercially available cleaning composition with citric acid as the main component was used as a control group (Chemical A). Cleaning tests on a Cu wafer after chemical mechanical polishing and a blank wafer were each carried out for 20 seconds with Chemical A and Chemical C on a Mesa machine from Applied Materials, Inc., in which the flow rate of the cleaning agent was 2000 ml/min. The commercially available cleaning composition with citric acid as the main component and with a surface tension of 72 mN/m (control group, Chemical A) was tested under the same cleaning conditions.

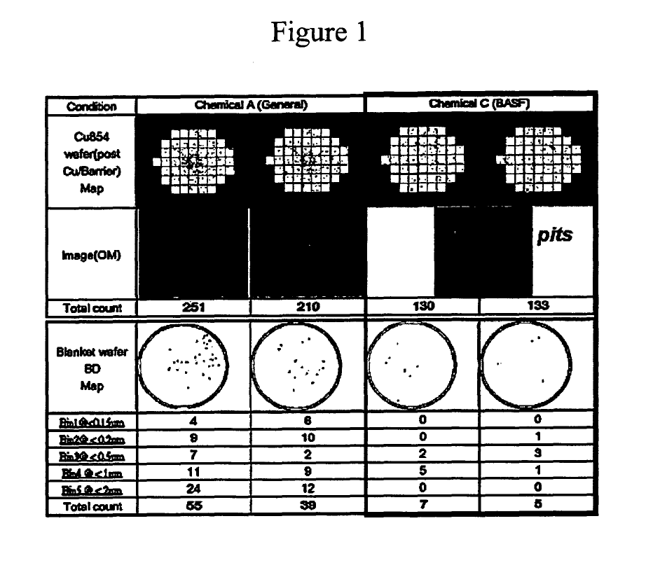

After cleaning, the defect counts on the surfaces of the test wafers were measured by a KLA-Tencor surfscan AIT. The results were shown in FIG. 1.

The results indicate that the cleaning effect of the cleaning composition of the present invention (Chemical C) is superior to that of the cleaning composition A (Chemical A). The results obtained by cleaning the Cu wafer and the blank wafer with Chemical C show that the total defect count is less than that obtained with Chemical A. Furthermore, the test results of the Cu wafer after it is cleaned with Chemical C and the blank wafer after it is cleaned with Candela CS10 show that the surface thickness of the wafer before and after the cleaning is unchanged, that is, Chemical C of the present invention will not etch the surface of the wafer.

### Examples 2 and 3

In a manner similar to that in Example 1, the cleaning compositions of the present invention were formulated and tested as follows:

| | Hydrazine | BDG | Deionized Water | Surface Tension |
|---|---|---|---|---|
| | (wt %) | (wt %) | (wt %) | (mN/m) |
| Embodiment 2 | 3 | 20 | 77 | 30.85 |
| Embodiment 3 | 8 | 20 | 72 | 29.5 |

It is found from the test results that the cleaning effects of all the compositions above are superior to those of the commercially available composition. The cleaning compositions of the present invention have low surface tension and can increase the wettability of the surface of the wafer, thus having better cleaning effects.

1. A composition, comprising:
about 1 to about 30 wt % of a water soluble amine;
about 10 to about 59 wt % of a water soluble organic solution; and
about 30 to about 89 wt % of deionized water, based on a total weight of the composition,
wherein the composition is suitable for post-chemical mechanical polishing cleaning.

2. The composition of claim 1, wherein the water soluble amine is at least one selected from the group consisting of hydrazine and a hydrazine hydrate.

3. The composition of claim 1, wherein the water soluble organic solvent is at least one selected from the group consisting of dimethyl sulfoxide (DMSO), a diol compound, N-methyl pyrrolidone (NMP), dimethyl acetamide (DMAC), and dimethyl formamide (DMF).

4. The composition of claim 3, wherein the diol compound is at least one selected from the group consisting of diethylene glycol monobutyl ether (BDG), ethylene glycol monoethyl ether, ethylene glycol dimethyl ether, ethylene glycol n-butyl ether, and ethylene glycol monobutyl ether acetate.

5. The composition of claim 1, wherein the water soluble amine is present in an amount of about 1 to about 25 wt %.

6. The composition of claim 5, wherein the water soluble amine is present in an amount of about 1 to about 10 wt %.

7. The composition of claim 1, wherein the water soluble organic solvent is present in an amount of about 10 to about 50 wt %.

8. The composition of claim 7, wherein the water soluble organic solvent is present in an amount of about 10 to about 25 wt %.

9. The composition of claim 1, wherein the deionized water is present in an amount of about 50 to about 85 wt %.

10. The composition of claim 9, wherein the deionized water is present in an amount of about 65 to about 85 wt %.

11. A method of post CMP cleaning, comprising:
contacting a wafer which undergoes CMP with the composition of claim 1 for an effective duration to remove residual contaminants on the wafer.

12. The composition of claim 1, wherein the water soluble amine comprises hydrazine hydrate.

13. The composition of claim 1, wherein the water soluble amine comprises hydrazine hydrate.

14. The composition of claim 1, wherein the water soluble amine comprises hydrazine and a hydrazine hydrate.

15. The composition of claim 1, wherein the water soluble organic solvent comprises dimethyl sulfoxide (DMSO).

16. The composition of claim 1, wherein the water soluble organic solvent comprises a diol compound.

17. The composition of claim 1, wherein the water soluble organic solvent comprises N-methyl pyrrolidone (NMP).

18. The composition of claim 1, wherein the water soluble organic solvent comprises dimethyl acetamide (DMAC).

19. The composition of claim 1, wherein the water soluble organic solvent comprises dimethyl formamide (DMF).

20. The composition of claim 3, wherein the diol compound comprises diethylene glycol monobutyl ether (BDG).
